(19) United States
(12) Patent Application Publication
(10) Pub. No.: US 2020/0256442 A1
(43) Pub. Date: Aug. 13, 2020

(54) TORQUE CONVERTER CLUTCH

(71) Applicant: GM Global Technology Operations LLC, Detroit, MI (US)

(72) Inventors: Edward W. Mellet, Rochester Hills, MI (US); Leonid Basin, Farmington Hills, MI (US); Joel H. Gunderson, Canton, MI (US)

(21) Appl. No.: 16/269,901

(22) Filed: Feb. 7, 2019

(51) Int. Cl. F16H 45/02; F16D 25/0638

(52) U.S. Cl. CPC F16H 45/02; F16D 25/0638

(57) ABSTRACT

A torque converter for a vehicle includes an annular housing. A turbine member is fluidically connected to the pump member. A lock-up clutch is selectively engaged between the annular housing and the turbine member. A lock-up clutch actuator is connected to the lock-up clutch. A cavity is defined between the annular housing and the turbine member. A first fluid circuit is fluidically connected to the pump member, the cavity and a first side of the lockup clutch actuator. The first fluid circuit delivers a fluid to engage the lock-up clutch actuator. A second fluid circuit is hydraulically connected to the pump member and the cavity. The second fluid circuit guide the fluid from the annular housing. A third fluid circuit is hydraulically connected to a second side of the lock-up clutch actuator. The third fluid circuit selectively delivers a pressurized fluid to release the lock-up clutch.

### INTRODUCTION

The subject disclosure relates to the art of automatic transmissions and, more particularly, to a clutch in a torque converter of an automatic transmission.

Automatic transmissions provide a plurality of gears that may be selectively activated or engaged by application of one or more brakes or clutches. Clutches are typically located in a torque converter that receives hydraulic fluid from pumps arranged in the transmission. The torque converter is a fluid coupling that may exist between a prime mover and the automatic transmission. The pressure needed to engage the clutches is relatively high. Thus, the number of clutches that may be engaged at a given time may be limited. Accordingly, it is desirable to provide a torque converter that may provide additional pressure options to improve vehicle operating characteristics.

### SUMMARY

In one exemplary embodiment a torque converter for a vehicle includes an annular housing, and a pump member connected to the annular housing. A turbine member is fluidically connected to the pump member. A lock-up clutch is selectively engaged between the annular housing and the turbine member. A lock-up clutch actuator is connected to the lock-up clutch. A cavity is defined between the annular housing and the turbine member. A first fluid circuit is fluidically connected to the pump member, the cavity, and a first side of the lock-up clutch actuator. The first fluid circuit is selectively delivers a fluid to engage the lock-up clutch actuator. A second fluid circuit is hydraulically connected to the pump member and the cavity, the second fluid circuit guides the fluid from the annular housing. A third fluid circuit is hydraulically connected to a second side of the lock-up clutch actuator. The third fluid circuit selectively delivers a pressurized fluid to release the lock-up clutch.

In addition to one or more of the features described above or below, or as an alternative, further embodiments could include wherein the at least one shaft includes an input shaft and a stationary shaft extending about the input shaft, wherein the turbine member includes a stator rotationally mounted to the stationary shaft.

In addition to one or more of the features described above or below, or as an alternative, further embodiments could include wherein the third fluid circuit passes within the input shaft.

In addition to one or more of the features described above or below, or as an alternative, further embodiments could include wherein the first fluid circuit passes between the input shaft and the stationary shaft.

In addition to one or more of the features described above or below, or as an alternative, further embodiments could include wherein the lock-up clutch actuator is rotatably mounted to the stationary shaft.

In addition to one or more of the features described above or below, or as an alternative, further embodiments could include a spring arranged between the annular housing and the lock-up clutch actuator.

In addition to one or more of the features described above or below, or as an alternative, further embodiments could include a support member mounted to the stationary shaft spaced from the lock-up clutch actuator, the support member being mechanically connected to the lock-up clutch actuator.

In addition to one or more of the features described above or below, or as an alternative, further embodiments could include a spring arranged between the lock-up clutch and the lock-up clutch actuator.

In accordance with another aspect of an exemplary embodiment, a vehicle includes a prime mover, an automatic transmission, and a torque converter operatively connecting the prime mover and the automatic transmission. The torque converter includes an annular housing and a pump member connected to the annular housing. A turbine member is fluidically connected to the pump member. A lock-up clutch is selectively engaged between the annular housing and the turbine member. A lock-up clutch actuator is connected to the lock-up clutch. A cavity is defined between the annular housing and the turbine member. A first fluid circuit is fluidically connected to the pump member, the cavity, and a first side of the lock-up clutch actuator. The first fluid circuit selectively delivers a fluid to engage the lock-up clutch actuator. A second fluid circuit hydraulically connected to the pump member and the cavity, the second fluid circuit guides the fluid from the annular housing. A third fluid circuit is hydraulically connected to a second side of the lock-up clutch actuator. The third fluid circuit selectively delivers a pressurized fluid to release the lock-up clutch.

In addition to one or more of the features described above or below, or as an alternative, further embodiments could include wherein the at least one shaft includes an input shaft and a stationary shaft extending about the input shaft, wherein the turbine member includes a stator rotationally mounted to the stationary shaft.

In addition to one or more of the features described above or below, or as an alternative, further embodiments could include wherein the third fluid circuit passes within the input shaft and the first fluid circuit passes between the input shaft and the stationary shaft.

In addition to one or more of the features described above or below, or as an alternative, further embodiments could include a spring arranged between the annular housing and the lock-up clutch actuator.

In addition to one or more of the features described above or below, or as an alternative, further embodiments could include a support member mounted to the stationary shaft spaced from the lock-up clutch actuator, the support member being mechanically connected to the lock-up clutch actuator.

In addition to one or more of the features described above or below, or as an alternative, further embodiments could include a spring arranged between the lock-up clutch and the lock-up clutch actuator.

In accordance with yet another aspect of an exemplary embodiment, a method of operating a torque converter includes delivering a first fluid through a first fluid circuit toward a pump member of the torque converter, passing the first fluid to a first side of a lock-up clutch actuator. The first fluid urges the lock-up clutch actuator to a locked configuration. A second fluid is passed from the torque converter through a second fluid circuit. A third fluid is passed through a third fluid circuit to a second, opposing side of the lock-up clutch actuator. Reducing a pressure of the third fluid releases the lock-up clutch actuator from the locked configuration.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a portion of the torque converter, in accordance with an aspect of an exemplary embodiment; and

FIG. 2 is a schematic diagram of a portion of a torque converter, in accordance with another aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

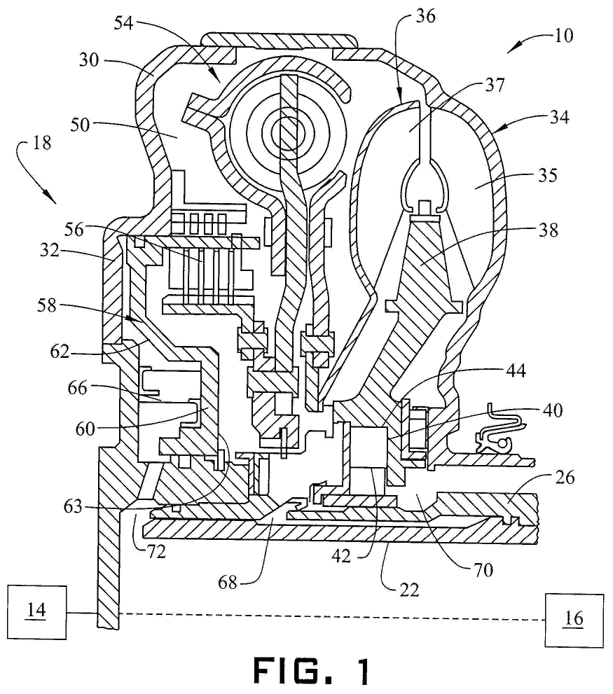

In accordance with an exemplary aspect, a schematic representation of a vehicle is shown generally at 10 in FIG. 1. Vehicle 10 includes a prime mover 14 connected to an automatic transmission 16. A torque converter 18 couples prime mover 14 to automatic transmission 16. In and embodiment, automatic transmission 16 includes an output shaft (not shown) that mechanically connects with torque converter 18. Torque converter 18 is also shown in include an input shaft 22, and a stationary shaft 26 circumferentially surrounding input shaft 22. At this point, it should be understood that input shaft 22 may be considered to be as an output shaft of automatic transmission 16.

In accordance with an exemplary aspect, torque converter 18 includes a housing 30 having an end wall 32. Torque converter 18 further includes a pump member 34 and a turbine member 36. Pump member 34 is generally annular in shape and includes a plurality of pump fins, one of which is shown at 35. Pump fins 35 are oriented to transfer rotational energy from pump member 34 to a hydraulic fluid (not shown) disposed within housing 30. Turbine member 36 is likewise generally annular in shape and includes a plurality of turbine fins, one of which is indicated at 37 that oppose the pump fins in pump member 34. Turbine fins 37 are oriented to transfer energy from the hydraulic fluid to turbine member 36. At this point, it should be appreciated that the general shape, and dimensions of pump member 34 and turbine member 36 may vary and could depend on various design considerations.

Torque converter 18 also includes a stator or reactor 38 rotatably coupled through a one way clutch 40 to stationary shaft 26. Stator 38 includes a plurality of fins (not shown) extending radially outwardly from a center portion (not separately labeled) to redirect hydraulic fluid that exits turbine member 36. The angled fins may take on various forms including fixed angle fins and adjustable angle fins. In the embodiment shown, one way clutch 40 includes a first race 42 coupled to stationary shaft 26 and a second race 44 coupled to stator 38. One way clutch 40 allows rotation of stator 38 in a direction of pump member 34 while resisting rotation in an opposing direction. In an embodiment, stationary shaft 26 is coupled to a stationary component (not shown) in automatic transmission 16. In should be understood that in some embodiments, torque converter 18 may take the form of a fluid coupling devoid of a stator.

In an embodiment, housing 30 takes the form of an annular component that is rotatably coupled with pump member 34. Housing 30 extends axially away from pump member 34 to end wall 32 and defines a cavity 50. A lock-up clutch 56 is selectively actuated to lock rotation of housing 30 and turbine member 36. Lock-up clutch 56 is mounted to a lock-up clutch actuator 58 that is mechanically linked to input shaft 22. In an embodiment, lock-up shaft actuator 58 takes the form of a piston 60 that is acted upon by pressurized hydraulic fluid to engage lock-up clutch 56 to housing 30. Piston 60 includes a first side 62 and an opposing second side 63. A spring 66 is disposed between end wall 32 and first side 62.

In accordance with an exemplary embodiment, torque converter 18 includes a first fluid circuit 68 that is disposed between input shaft 22 and stationary shaft 26, a second fluid circuit 70 that is disposed radially outwardly of stationary shaft 26, and a third fluid circuit 72 that is disposed within input shaft 22. First fluid circuit 68, second fluid circuit 70, and third fluid circuit 72 deliver hydraulic fluid to select portions of torque converter 18 to provide fluid to pump member 34 and to selectively actuate and release lock-up clutch 56.

In accordance with an exemplary aspect, a first hydraulic fluid is passed from automatic transmission 16 through first fluid circuit 68 into cavity 50 and provides a charge fluid for pump member 34 and turbine member 36 as well as an activation pressure for lock-up clutch 56. More specifically, the first hydraulic fluid passing through first fluid circuit 68 acts upon second side 63 of piston 60 to cause lock-up clutch 56 to engage with end wall 32. A third hydraulic fluid passes through third fluid circuit 72 and may be employed to release lock-up clutch 56.

The third hydraulic fluid passes through third fluid circuit 72 and acts upon first side 62 at a release pressure sufficient to overcome the activation pressure allowing lock-up clutch 56 to disengage. The release pressure may be selected to cooperate with pressure from spring 66 to selectively release lock-up clutch 56. The hydraulic fluid passing through first fluid circuit 68 and third fluid circuit 72 may flow back to automatic transmission 16 as a second hydraulic fluid via second fluid circuit 70. At this point, it should be understood that that terms first, second, and third hydraulic fluids are used to enhance understanding of fluid flow and is not meant to describe the use of separate or distinct fluids.

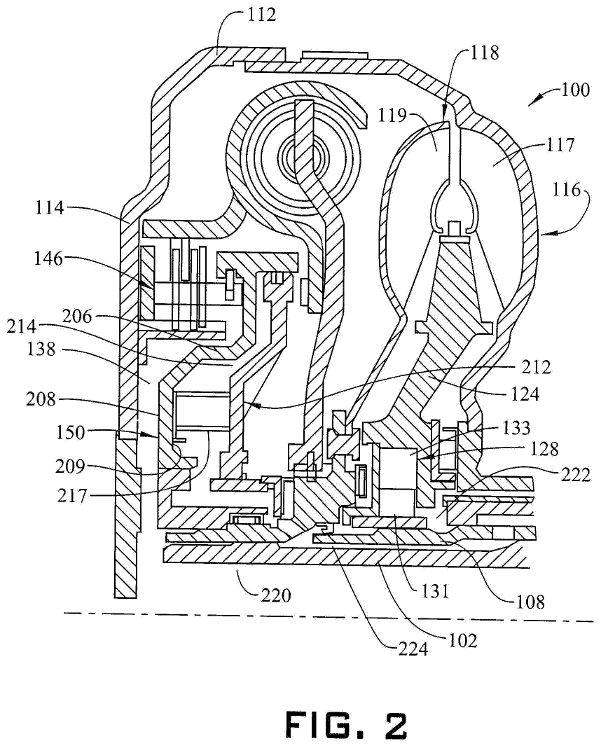

Reference will now follow to FIG. 2 in describing a torque converter 100 in accordance with another aspect of an exemplary embodiment. Torque converter 100 is shown to include an input shaft 102 and a stationary shaft 108 arranged radially outwardly of input shaft 102. At this point, it should be understood that input shaft 102 may be considered to be an output shaft of automatic transmission 16 (FIG. 1).

In accordance with an exemplary aspect torque converter 100 includes a housing 112 having an end wall 114. Torque converter 100 further includes a pump member 116 and a turbine member 118. Pump member 116 is generally annular in shape and includes a plurality of pump fins, one of which is indicated at 117. Pump fins 117 are oriented to transfer rotational energy from pump member 116 to a hydraulic fluid (not shown) disposed within housing 112. Turbine member 118 is likewise generally annular in shape and includes a plurality of turbine fins, one of which is indicated at 119 that oppose the pump fins in pump member 116. Turbine fins are oriented to transfer energy from the hydraulic fluid to turbine member 118. At this point, it should be appreciated that the general shape, and dimensions of pump member 116 and turbine member 118 may vary and could depend on various design considerations.

Torque converter 100 also includes a stator or reactor 124 rotatably coupled through a one way clutch 128 to stationary shaft 108. Stator 124 includes a plurality of fins (not shown) extending radially outwardly from a center portion (not separately labeled) to redirect hydraulic fluid that exits turbine member 118. The angled fins may take on various forms including fixed angle fins and adjustable angle fins. In an embodiment, one way clutch 128 includes a first race 131 coupled to stationary shaft 108 and a second race 133 coupled to stator 124. One way clutch 128 allows rotation of stator 124 in a direction of pump member 116 while resisting rotation in an opposing direction. In an embodiment, stationary shaft 108 is coupled to a stationary component (not shown) in automatic transmission 16. In should be understood that in some embodiments, torque converter 18 may take the form of a fluid coupling devoid of a stator.

In an embodiment, housing 112 takes the form of an annular component that is rotatably coupled with pump member 116. Housing 112 extends axially away from pump member 116 to end wall 114 and defines a cavity 138. A lock-up clutch 146 is selectively actuated to lock rotation of housing 112 and turbine member 118. Lock-up clutch 146 is mounted to a lock-up clutch actuator 150 that is mechanically linked to input shaft 102.

In an embodiment, lock-up shaft actuator 150 takes the form of a piston 206 that is acted upon by pressurized hydraulic fluid to engage lock-up clutch 146 thereby connecting turbine member 118 and housing 112. Piston 206 includes a first side 208 and an opposing second side 209. In accordance with an exemplary aspect, a support member 212 is positioned radially inwardly of and operatively connected to lock-up clutch actuator 150. A cavity portion 214 is defined between second side 209 of lock-up clutch actuator 150 and support member 212. A spring 217 is arranged in cavity portion 214. Spring 217 acts upon second side 209 and support member 212.

In accordance with an exemplary embodiment, torque converter 100 includes a first fluid circuit 220, a second fluid circuit 222 that is disposed radially outwardly of stationary shaft 108, and a third fluid circuit 224 that is disposed between input shaft 102 and stationary shaft 108. First fluid circuit 220, second fluid circuit 222, and third fluid circuit 224 deliver hydraulic fluid to select portions of torque converter 100 to provide fluid to pump member 116 and to selectively actuate and release lock-up clutch 146.

In accordance with an exemplary aspect, a first hydraulic fluid is passed from automatic transmission 16 through first fluid circuit 220 into cavity 138. The first fluid passes through first fluid circuit 220 provides a charge fluid for pump member 116 and turbine member 118 as well as an activation pressure for lock-up clutch 146. More specifically, the hydraulic fluid passing through first fluid circuit 220 acts upon first side 208 of piston 206 to cause lock-up clutch 146 to engage with end wall 114. A third hydraulic fluid passes through third fluid circuit 224 and may be employed to release lock-up clutch 56.

The third hydraulic fluid passes through third fluid circuit 224 into cavity portion 214 and acts upon second side 209 of piston 206 at a release pressure sufficient to overcome the activation pressure allowing lock-up clutch 146 to disengage. The release pressure may be selected to cooperate with pressure from spring 217 to selectively release lock-up clutch 146. The hydraulic fluid passing through first fluid circuit 220 and third fluid circuit 224 may flow back to automatic transmission 16 as a second hydraulic fluid via second fluid circuit 222. At this point, it should be understood that that terms first, second, and third hydraulic fluids are used to enhance understanding of fluid flow and is not meant to describe the use of separate or distinct fluids.

At this point, it should be understood that the exemplary embodiments describe a torque converter that utilizes torque converter charge fluid to not only provide a fluid volume for a pump member, but also provides lock-up clutch activation pressure. The lock-up clutch may then be release by adjusting a pressure of a separate compensation oil circuit that may provide rotational fluid balance to the charge pressure acting on the lock-up clutch.

The terms “about” and “substantially” are intended to include the degree of error associated with measurement of the particular quantity based upon the equipment available at the time of filing the application. For example, “about” and “substantially” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A torque converter for a vehicle comprising:
an annular housing;
a pump member connected to the annular housing;
a turbine member fluidically connected to the pump member;
a lock-up clutch selectively engaged between the annular housing and the turbine member;
a lock-up clutch actuator connected to the lock-up clutch;
a cavity defined between the annular housing and the turbine member;
a first fluid circuit fluidically connected to the pump member, the cavity, and a first side of the lock up clutch actuator, the first fluid circuit selectively delivering a fluid to engage the lock-up clutch actuator;
a second fluid circuit hydraulically connected to the pump member and the cavity, the second fluid circuit guiding the fluid from the annular housing; and
a third fluid circuit hydraulically connected to a second side of the lock-up clutch actuator, wherein the third fluid circuit selectively delivers a pressurized fluid to release the lock-up clutch.

2. The torque converter according to claim 1, further comprising: an input shaft and a stationary shaft extending about the input shaft, wherein the turbine member includes a stator rotationally mounted to the stationary shaft.

3. The torque converter according to claim 2, wherein the third fluid circuit passes within the input shaft.

4. The torque converter according to claim 3, wherein the first fluid circuit passes between the input shaft and the stationary shaft.

5. The torque converter according to claim 2, wherein the lock-up clutch actuator is rotatably mounted to the stationary shaft.

6. The torque converter according to claim 5, further comprising: a spring arranged between the annular housing and the lock-up clutch actuator.

7. The torque converter according to claim 5, further comprising: a support member mounted to the stationary shaft spaced from the lock-up clutch actuator, the support member being mechanically connected to the lock-up clutch actuator.

8. The torque converter according to claim 7, further comprising: a spring arranged between the lock-up clutch and the lock-up clutch actuator.

9. A vehicle comprising:
a prime mover;
an automatic transmission; and
a torque converter operatively connecting the prime mover and the automatic transmission, the torque converter comprising:
an annular housing;
a pump member connected to the annular housing;
a turbine member fluidically connected to the pump member;
a lock-up clutch selectively engaged between the annular housing and the turbine member;
a lock-up clutch actuator connected to the lock-up clutch;
a cavity defined between the annular housing and the turbine member;
a first fluid circuit fluidically connected to the pump member, the cavity, and a first side of the lock up clutch actuator, the first fluid circuit selectively delivering a fluid to engage the lock-up clutch actuator;
a second fluid circuit hydraulically connected to the pump member and the cavity, the second fluid circuit guiding the fluid from the annular housing, and
a third fluid circuit hydraulically connected to a second side of the lock-up clutch actuator, wherein the third fluid circuit selectively delivers a pressurized fluid to release the lock-up clutch.

10. The vehicle according to claim 9, further comprising an input shaft and a stationary shaft extending about the input shaft, wherein the turbine member includes a stator rotationally mounted to the stationary shaft.

11. The vehicle according to claim 10, wherein the third fluid circuit passes within the input shaft and the first fluid circuit passes between the input shaft and the stationary shaft.

12. The vehicle according to claim 9, further comprising: a spring arranged between the annular housing and the lock-up clutch actuator.

13. The vehicle according to claim 10, further comprising: a support member mounted to the stationary shaft spaced from the lock-up clutch actuator, the support member being mechanically connected to the lock-up clutch actuator.

14. The vehicle according to claim 13, further comprising: a spring arranged between the lock-up clutch and the lock-up clutch actuator.

15. A method of operating a torque converter comprising:
delivering a first fluid through a first fluid circuit toward a pump member of the torque converter;
passing a the first fluid to a first side of a lock-up clutch actuator, the first fluid urging the lock-up clutch actuator to a locked configuration;
guiding a second fluid from the torque converter through a second fluid circuit; and
passing a third fluid through a third fluid circuit to a second, opposing side of the lock-up clutch actuator, wherein reducing a pressure of the third fluid releases the lock-up clutch actuator from the locked configuration.
